(19) United States
(12) Patent Application Publication
(10) Pub. No.: US 2002/0039884 A1
(43) Pub. Date: Apr. 4, 2002

(54) Radio communication system

(75) Inventors: Deborah L. Raynes, Horley (GB); David H. Evans, Crawley (GB); Matthew P.J. Baker, Canterbury (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V..

(21) Appl. No.: 09/995,488

(22) Filed: Nov. 28, 2001

(30) Foreign Application Priority Data
Feb. 12, 2000 (GB) 0029426.4

(51) Int. Cl. H04B 7/185

(52) U.S. Cl. 455/13.3; 455/453; 455/41

(57) ABSTRACT

A radio communication system comprises a communication channel between a transmitter having parts operating according to a plurality of radio standards and having a plurality of antennas and a receiver having parts operating according to a corresponding plurality of radio standards having at least one antenna. In such a system the communication channel comprises a plurality of paths having a range of characteristics. Data for transmission is generated by one or more applications and is transmitted using an appropriate radio standard.

In one embodiment, the data has one or more categories assigned to it, for example by the addition of tags by a tagging block indicating its importance or other requirements. Depending on the assigned categories and the characteristics of the paths, the data is mapped to one or more of the transmitter's parts and antennas to select a suitable radio air interface and transmission path.

The present invention relates to a radio communication system having a communication channel comprising a plurality of paths between a transmitter and a receiver, the transmitter comprising a plurality of antennas and the receiver comprising at least one antenna. In the present specification, path is used to refer to an individual sub-channel which is resolvable within the overall radio system, and channel is used to refer to the combined totality of paths between the transmitter and the receiver.

In a radio communication system, radio signals typically travel from a transmitter to a receiver via a plurality of paths, each involving reflections from one or more scatterers. Received signals from the paths may interfere constructively or destructively at the receiver (resulting in position-dependent fading). Further, differing lengths of the paths, and hence the time taken for a signal to travel from the transmitter to the receiver, may cause inter-symbol interference.

It is well known that the above problems caused by multipath propagation can be mitigated by the use of multiple antennas at the receiver (receive diversity), which enables some or all of the multiple paths to be resolved. For effective diversity it is necessary that signals received by individual antennas have a low cross-correlation. Typically this is ensured by separating the antennas by a substantial fraction of a wavelength, although closely-spaced antennas may also be employed by using techniques disclosed in our co-pending unpublished International patent application PCT/EPO1/02750 (applicant's reference PHGB000033). By ensuring use of substantially uncorrelated signals, the probability that destructive interference will occur at more than one of the antennas at any given time is minimised.

Similar improvements may also be achieved by the use of multiple antennas at the transmitter (transmit diversity). Diversity techniques may be generalised to the use of multiple antennas at both transmitter and receiver, known as a Multi-Input Multi-Output (MIMO) system, which can further increase system gain over a one-sided diversity arrangement. As a further development, the presence of multiple antennas enables spatial multiplexing, whereby a data stream for transmission is split into a plurality of sub-streams, each of which is sent via a different path (or sub-channel). One example of such a system is described in U.S. Pat. No. 6,067,290.

The performance gains which may be achieved from a MIMO system may be used to increase the total data rate at a given error rate, or to reduce the error rate for a given data rate, or some combination of the two. A MIMO system can also be controlled to reduce the total transmitted energy or power for a given data rate and error rate.

An object of the present invention is to provide a MIMO system having improved performance.

According to a first aspect of the present invention there is provided a radio communication system having a communication channel comprising a plurality of paths between a transmitter and a receiver each having a plurality of antennas, wherein the transmitter and receiver are operable according to at least two radio standards simultaneously.

According to a second aspect of the present invention there is provided a transmitter for use in a radio communication system having a communication channel comprising a plurality of paths between a transmitter and a receiver each having a plurality of antennas, wherein means are provided for simultaneous operation of the transmitter according to at least two radio standards.

According to a third aspect of the present invention there is provided a receiver for use in a radio communication system having a communication channel comprising a plurality of paths between a transmitter and a receiver each having a plurality of antennas, wherein means are provided for simultaneous operation of the receiver according to at least two radio standards.

According to a fourth aspect of the present invention there is provided a method of operating a radio communication system having a communication channel comprising a plurality of paths between a transmitter and a receiver each having a plurality of antennas, the method comprising simultaneously transmitting according to at least two radio standards.

The present invention is based upon the recognition, not present in the prior art, that a multi-mode MIMO system can provide enhanced performance, which may improve the convergence of wireless standards.

Embodiments of the present invention will now be described, by way of example, with reference to the accompanying drawings, wherein:

FIG. 1 is a block schematic diagram of a known MIMO radio system;

FIG. 2 is a block schematic diagram of a MIMO radio system made in accordance with the present invention;

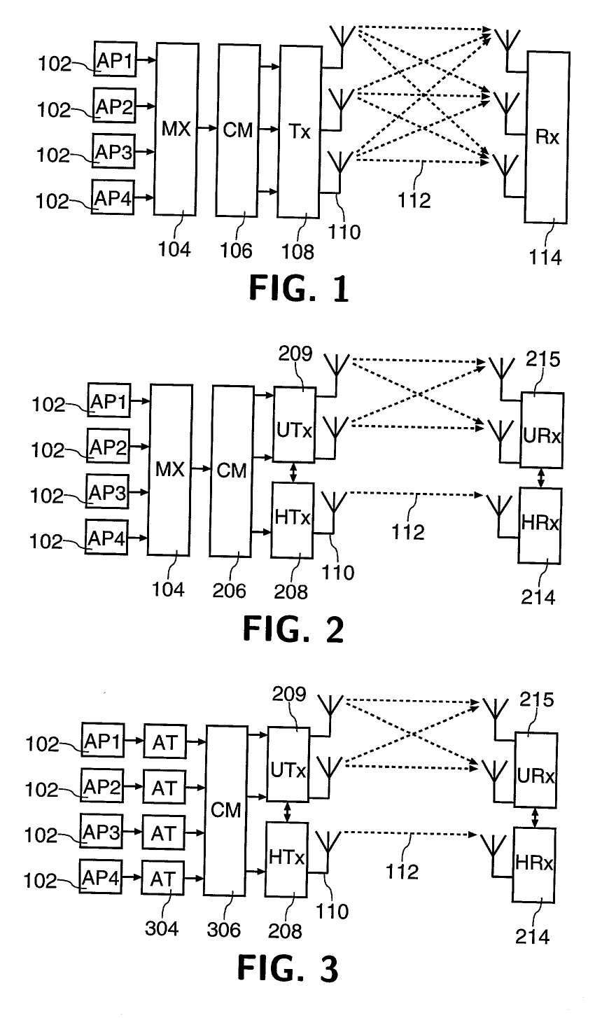

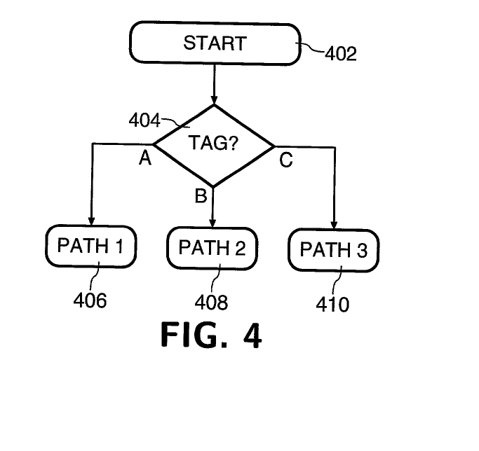

FIG. 3 is a block schematic diagram of an enhanced MIMO radio system; and

FIG. 4 is a flow chart illustrating a method of operating a MIMO radio system in accordance with the present invention.

In the drawings the same reference numerals have been used to indicate corresponding features.

FIG. 1 illustrates a known MIMO radio system. A plurality of applications 102 (AP1 to AP4) generate data streams for transmission. An application 102 could also generate a plurality of data streams. The data streams are combined by a multiplexer (MX) 104 into a single data stream, which is further processed by a coding and mapping block (CM) 106. The CM block may apply space-time coding to provide a mapping between data symbols to be transmitted by a transmitter (Tx) 108, together with suitable forward error correction, and multiple transmit antennas 110. The Forward Error Correction (FEC) which is applied by the CM block must therefore have sufficient error-correcting ability to cope with the entire MIMO channel, which comprises a plurality of paths 112. For simplicity of illustration only direct paths 112 between antennas 110 are illustrated, but it will be appreciated that the set of paths will typically include indirect paths where signals are reflected by one or more scatterers.

A number of space-time coding techniques are known in the prior art and may be employed by the coding and mapping block 106. These may further include diversity and beam forming techniques to aid the selection of radio paths to the receiver. Examples of suitable techniques include but are not limited to those described in chapters 2, 5 and 8 of “Space-Time Processing for CDMA Mobile Communications”, van Rooyen et al, Kluwer Academic Publishers 2000.

A receiver (Rx) 114, also provided with a plurality of antennas 110, receives signals from the multiple paths which it then combines, decodes and demultiplexes to provide respective data streams to each application. Although both the transmitter 112 and receiver 114 are shown as having the same number of antennas, this is not necessary in practice and the numbers of antennas can be optimised depending on space and capacity constraints. Similarly, the transmitter 108 may support any number of applications (for example, a single application on a voice-only mobile telephone or a large number of applications on a PDA).

A major trend in the development of wireless systems is towards the convergence of wireless standards, such as UMTS (Universal Mobile Telecommunication System) HIPERLAN (HIgh PErformance Radio Local Area Network). As one example of the possibilities this provides, our co-pending unpublished United Kingdom patent application 0019534.7 (applicant's reference PHGB000107) discloses a combined UMTS/HIPERLAN system in which one of an uplink and a downlink channel is shared between the two modes, thereby enabling a more economical terminal and a more efficient system. Other work is concentrating on developing suitable interfaces to allow a common IP (Internet Protocol) layer.

As a result of the convergence of radio standards, it will become practical for future radio systems to enable roaming across more than one type of radio system, with the use of multi-mode terminals, thereby requiring greater system capacity. In a system made in accordance with the present invention, the additional capacity provided by MIMO systems is used to enable such roaming.

There are a range of scenarios in which a multi-mode MIMO system could be employed, for example:

A generic multi-mode MIMO system supporting multiple standards, enabling the use of a single physical terminal for all modes. The use of MIMO would provide sufficient capacity for all modes to operate simultaneously.

A MIMO embodiment of a first system to increase the number of channels and system capacity, enabling services for a second sytem to be operated via the interface of the first system. The first and second systems could for example be UMTS and HIPERLAN or vice-versa. Such an embodiment could make use of the techniques disclosed in our co-pending unpublished United Kingdom patent application 0019534.7 (applicant's reference PHGB000107) for sharing an air interface between two radio systems.

A MIMO embodiment of a plurality of separate systems to increase system capacity, thereby allowing splitting of services between the systems.

FIG. 2 illustrates one embodiment of the last-mentioned arrangement, based on the known arrangement of FIG. 1. In this embodiment the transmitter 108 of FIG. 1 is replaced by a transmitter having a HIPERLAN part (HTx) 208 and a UMTS part (UTx) 209, which parts communicate with one another and to an adapted coding and mapping block 206. Similarly, the single receiver 114 is replaced by a receiver having a HIPERLAN part (HRx) 214 and a UMTS part (URx) 215. As illustrated the UMTS parts 209,215 are each connected to two antennas and the HIPERLAN parts 208,214 are each connected to a single antenna. However, this arrangement can readily be varied to take account of the requirements of the system, thereby altering the number of paths and system capacity. The coding and mapping block 206 arranges for the data to be split between UMTS and HIPERLAN parts as appropriate. Such an arrangement provides improved system operation by enabling data streams to be transmitted via the most suitable path of the most suitable system. An advantage of a combined UMTS/HIPERLAN system is that the set of paths for the UMTS part (at 2 GHz) will typically be significantly different to those for the HIPERLAN part (at 5 GHz), even if the same antenna is used, thereby adding another dimension to the space-time MIMO arrangement.

A further problem with MIMO systems such as those described above is that they take no account of the fact that the various paths 112 between transmitter 108 and receiver 114 will differ in their impulse responses, resulting in differences in Signal-to-Noise Ratio (SNR) and time delay. The number of paths 112 which can be used is restricted by the quality of available paths.

In an enhancement to the above systems, a data stream is mapped to the different transmit antennas 110 according to the differing requirements of individual portions of data. In order to implement such a system, prior knowledge of the characteristics of the different paths 112 is required. This knowledge may be obtained by transmitting pilot bits from each antenna to enable the receiver 114 to conduct channel estimation in a known manner, for example as defined for HIPERLAN/2. The channel estimate may then be transmitted back to the transmitter 108 to enable it to determine how to assign and code data for the different antennas 110. Alternatively, the estimate could be derived from bit or block error rates of data previously received via the different radio paths 112 or by other appropriate techniques.

If the uplink and downlink channels are known to be at least approximately reciprocal, for example in a Time Division Duplex system having a coherence time greater than the closed-loop feedback delay, the channel estimation may be performed by the transmitter 108 on the basis of known pilot information or similar received from the receiver 114.

Data which requires a high Quality of Service (QoS) in terms of error rate, or simply requiring the highest available bit rate, is coded and mapped to the transmit antennas 110 in such a way as to make use of one or more paths 112 in the radio channel offering the best SNR (or which require the lowest transmit power for the required SNR). Data requiring a lower QoS in terms of error rate may be mapped to a path or paths 112 in the radio channel offering a lower value of SNR.

The distinction between different data bits with differing requirements may be made on the basis of the application from which the data emanates, for example a real-time high-quality video link may produce data to be transmitted which requires a lower error rate than voice data. In this case, instead of multiplexing the data streams from the different applications together above or at the physical layer in the transmitter, the streams would be kept separate until the process of mapping their respective data bits to the transmit antennas.

A modified MIMO system which implements this function, based on the system of FIG. 2, is shown in FIG. 3. The multiplexer 106 is now replaced by a plurality of tagging blocks (AT) 204, each connected to an application 102, which add a tag to the data from the respective application 102 providing information about its QoS requirements. The tagging blocks 304 may alternatively use other means for associating information regarding QoS requirements with the data; for example data with different QoS requirements may be delivered to the physical layer at different time instants or on different transport channels or to different ports. This QoS information is then used by a modified coding and mapping block 306 which adjusts the coding and mapping to meet the QoS requirements so far as possible by matching them to the properties of the radio paths 112.

The system of FIG. 3 could be modified if multiple applications had the same or similar requirements. In this case, data from these applications could be multiplexed above the physical layer.

Instead of, or in addition to, treating data from different applications differently, different data bits from a particular application could be coded and mapped to the transmit antennas 110 in such a way as to use particular radio paths according to differing requirements of the particular bits. As a typical example, a stream of data from a voice codec could have coded bits assigned to a range of classes depending on their level of importance. The most important bits could be transmitted via the highest quality paths 112, while the less important bits could use lower quality radio paths 112.

FIG. 4 is a flow chart illustrating this method of operating a MIMO system. The process starts, at step 402, when an application 102 has data for transmission. The application 102 tags segments of data depending on their requirements, and the value of this tag is checked at step 404. In this example, if the tag is ‘A’ (representing the most important data) the data is transmitted via a first path 112, at step 406, where the first path is a high quality HIPERLAN path. Similarly, if the tag is ‘B’ (representing data of medium importance) the data is transmitted via a second path 112, at step 408, where the second path is a medium quality UMTS path. Finally, if the tag is ‘C’ (representing data of low importance), the data is transmitted via a third path 112, at step 410, where the third path is a low quality UMTS path.

As a further variation, the level of FEC coding applied to the data could be varied depending on the quality of the radio paths 112 from each antenna 110. For example, a lower level of FEC could be used for data using the higher-quality paths 112. This in turn could reduce the overall amount of information being transmitted and therefore enable the transmitter power to be reduced, or alternatively a higher data rate could be supported.

A range of other variations on the basic scheme are also possible. For example:

The total transmission power could be divided between the multiple transmit antennas in such a way as to equalise the received SNR from each of the paths.

The data bits could be mapped according to the different delays of the various radio paths 112, with more important or more urgent bits (e.g. closed-loop power control commands where the loop delay is critical) being transmitted on the shorter paths

Data from a particular application could be mapped to those paths 112 which have equal or similar delays, in order to eliminate inter-symbol interference.

In each case, one or more of the priority, error rate and delay required for each set of data bits delivered to the coding and mapping block 206 for transmission by the transmitter 108 could be indicated to the physical layer by means of additional “tag” bits or by any suitable alternative means, such as those described above.

An advantage of a system such as that described above is that it enables the radio channel to be better suited to the requirements of the data which is being transmitted. This may in turn result in a reduced overall transmit power, or an increase in the achievable data rate.

A system made in accordance with the present invention may be enhanced by using a plurality of spatially-separated receivers or transmitters. A typical example of this would be where a single mobile station maintains communication links with a plurality of base stations. A downlink data stream is divided, at a network layer level, among the base station transceivers such that each supports part of the downlink data stream to a single mobile station. By making the division in the manner described above, the robustness of the overall connection will be enhanced. The plurality of data streams from the base stations are received by the mobile, and reassembled at a network level within the terminal to provide the complete application data. Uplink transmissions could be primarily to a single base station or divided between all of the base stations depending on capacity and other requirements.

As such a mobile moves between base stations it will continuously come into range of new base stations and go out of range of other base stations, although overall it maintains continued connections with several base stations. The handover between individual base stations can be either hard or soft, but the overall effect for the mobile is a very soft handover since it is always in stable communication with several base stations.

1. A radio communication system having a communication channel comprising a plurality of paths between a transmitter and a receiver each having a plurality of antennas, wherein the transmitter and receiver are operable according to at least two radio standards simultaneously.

2. A transmitter for use in a radio communication system having a communication channel comprising a plurality of paths between a transmitter and a receiver each having a plurality of antennas, wherein means are provided for simultaneous operation of the transmitter according to at least two radio standards.

3. A transmitter as claimed in claim 2, characterised in that air interface means are provided for each supported radio standard.

4. A transmitter as claimed in claim 2, characterised in that air interface means are provided for at least one supported radio standard and in that means are provided for transmitting data for a first radio standard via air interface means of a second radio standard.

5. A transmitter as claimed in claim 2, characterised in that the transmitter further comprises path characterisation means for determining at least one transmission property of each path, categorisation means for assigning a category to a set of data for transmission and means responsive to said category and said at least one transmission property for determining a coding and mapping to apply to the set of data to the transmitter's antennas, thereby determining over which path or paths the set of data will be transmitted.

6. A transmitter as claimed in claim 5, characterised in that the categorisation means is adapted to assign different categories to respective segments of data from an application depending on at least one of their relative importance, required quality of service, data rate, tolerable transmission delay and tolerable error rate.

7. A transmitter as claimed in claim 5, characterised in that the path characterisation means is adapted to determine at least one of a delay and a signal-to-noise ratio for each path.

8. A transmitter as claimed in claim 2, characterised in that the supported radio standards include UMTS and HIPERLAN.

9. A receiver for use in a radio communication system having a communication channel comprising a plurality of paths between a transmitter and a receiver each having a plurality of antennas, wherein means are provided for simultaneous operation of the receiver according to at least two radio standards.

10. A receiver as claimed in claim 9, characterised in that air interface means are provided for each supported radio standard.

11. A method of operating a radio communication system having a communication channel comprising a plurality of paths between a transmitter and a receiver each having a plurality of antennas, the method comprising simultaneously transmitting according to at least two radio standards.
